(19) United States
(12) Patent Application Publication
(10) Pub. No.: US 2014/0009701 A1
(43) Pub. Date: Jan. 9, 2014

(54) METHOD EXECUTED IN LIQUID CRYSTAL DEVICE AND LIQUID CRYSTAL GLASSES

(71) Applicant: Takaaki TANAKA, Matsumoto-shi (JP)

(72) Inventor: Takaaki TANAKA, Matsumoto-shi (JP)

(73) Assignee: SEIKO EPSON CORPORATION, Tokyo (JP)

(21) Appl. No.: 14/019,177

(22) Filed: Sep. 5, 2013

Related U.S. Application Data
(63) Continuation of application No. 13/043,670, filed on Mar. 9, 2011.

(30) Foreign Application Priority Data
Mar. 10, 2010 (JP) 2010-053630

(51) Int. Cl. G02F 1/133

(52) U.S. Cl. CPC G02F 1/13306
USPC 349/13

(57) ABSTRACT

A liquid crystal device at least includes a first liquid crystal panel assembly in which a phase difference decreases due to application of a voltage, a second liquid crystal panel assembly that is formed to overlap with the first liquid crystal panel assembly and in which the phase difference increases due to application of a voltage, a pair of polarizers that is formed to be interposed between the first liquid crystal panel assembly and the second liquid crystal panel assembly, an optical compensation plate that is formed to overlap with at least one of the pair of polarizers, and a control unit that controls the voltages applied to the first liquid crystal panel assembly and the second liquid crystal panel assembly.

### BACKGROUND

1. Technical Field

The present invention relates to a liquid crystal device and liquid crystal glasses, and more particularly to a technique enabling the repetition of opening and closing of transmitted light at high speeds.

2. Related Art

There is known a stereoscopic display device which enables a viewer to experience stereoscopic vision when a three-dimensional object is displayed on a two-dimensional screen. For example, there is known a method in which right eye images and left eye images respectively corresponding to both eyes of a human being are misaligned by an amount of the binocular parallax and alternately displayed in a time-divisional manner, and a viewer wears dedicated glasses and views the images.

As the dedicated glasses (stereopsis glasses), liquid crystal glasses are known in which two liquid crystal shutters are positioned in parallel. For example, during a display period for right eye images, a liquid crystal shutter for the right eye corresponding to the right eye of a viewer is opened (to transmit image light) and a liquid crystal shutter for the left eye is closed. In addition, during a display period for left eye images, the liquid crystal shutter for the left eye corresponding to the left eye of the viewer is opened and the liquid crystal shutter for the right eye is closed. The opening and closing of the liquid crystal shutters for the right eye and the left eye are synchronized with the alternating display of the right eye images and the left eye images, and thereby the viewer can realistically experience stereoscopic vision for the images of the three-dimensional object displayed on the two-dimensional plane.

However, as a general characteristic of the liquid crystal shutters, there is a problem in that the response speed thereof is low. Particularly, during a fall in the applied voltage, variation in the phase difference is much slower than during a rise in the applied voltage. For this reason, if the liquid crystal shutters are used as the stereopsis glasses, at the time of the change between the right eye images and left eye images, there is a problem in that the right eye images and left eye images are viewed at the same time (crosstalk), and thus the images look blurred.

In order to improve the crosstalk, for example, JP-A-8-171098 discloses an invention where liquid crystal shutters are formed by overlapping a TN type normally white liquid crystal panel with a TN type normally black liquid crystal panel, and the liquid crystal shutters compensate for a delay in the phase difference variation during the fall in the applied voltage.

In addition, for example, JP-A-11-38361 discloses a stereoscopic display device in which liquid crystal shutters are formed using ferroelectric liquid crystal and thus a response speed is improved.

Also, for example, JP-A-2009-152897 discloses a stereoscopic image display device in which the crosstalk is suppressed by opening liquid crystal shutters only during the vertical blank interval between the display periods for left eye images and right eye images.

However, the liquid crystal shutters disclosed in JP-A-8-171098 have a problem in that at least three polarizers are required, and thus the structure is complex and manufacturing costs are high. In addition, there is concern that images look dark due to a reduction in an amount of light to be transmitted by the three or more polarizers.

The stereoscopic display device disclosed in JP-A-11-38361 has a problem in that since the ferroelectric liquid crystal is used, the handling thereof is difficult. In other words, the ferroelectric liquid crystal is in a smectic liquid crystal phase and is close to a solid as compared with a nematic liquid crystal phase, and thus, for example, even if a liquid-like C phase is used, the viscosity is high and it is very difficult to inject it into cells of the liquid crystal panel. Also, there are problems in that since the electric field is fixed for a long time, deviations occur in ions inside the liquid crystal due to the polarization and burn-in is easily generated.

In the stereoscopic image display device disclosed in JP-A-2009-152897, since the crosstalk is suppressed by changing display timings in the liquid crystal display which displays left eye images and right eye images, and the opening and closing speed of the liquid crystal shutters is not improved, the effect of prevention of the crosstalk is limited. In addition, there is concern that images are seen to flicker according to a setting of the display timings.

### SUMMARY

An advantage of some aspects of the invention is to provide a liquid crystal device which realizes a high response speed with a relatively simple configuration.

Also, an advantage of another aspect of the invention is to provide liquid crystal glasses capable of efficiently suppressing the generation of crosstalk by using the liquid crystal device having a high response speed as shutters.

In order to solve the above-described problems, several aspects of the invention provide the following liquid crystal device and liquid crystal glasses.

In other words, according to an aspect of the invention, there is provided a liquid crystal device including a first liquid crystal panel assembly in which a phase difference decreases due to application of a voltage; a second liquid crystal panel assembly that is formed to overlap with the first liquid crystal panel assembly and in which the phase difference increases due to application of a voltage; a pair of polarizers that is formed to be interposed between the first liquid crystal panel assembly and the second liquid crystal panel assembly; an optical compensation plate that is formed to overlap with at least one of the pair of polarizers; and a control unit that controls the voltages applied to the first liquid crystal panel assembly and the second liquid crystal panel assembly.

With liquid crystals, variation in the phase difference is faster during the rise in the applied voltage than during the fall in the applied voltage. The first liquid crystal panel assembly in which the phase difference decreases due to the application of a voltage overlaps with the second liquid crystal panel assembly in which the phase difference increases due to the application of a voltage, the fact that the variation speed in the phase difference is larger during the rise in the applied voltage than during the fall in the applied voltage is used, and the rise in the voltage applied to the second liquid crystal panel assembly is overlapped with the fall in the voltage applied to the first liquid crystal panel assembly, thereby switching the liquid crystal shutters from the closing state to the opening state in a short time. Therefore, it is possible to implement the high speed liquid crystal shutters with a relatively simple configuration.

It is preferable that the control unit performs a control such that the voltage applied to the first liquid crystal panel assembly falls and simultaneously the voltage applied to the second liquid crystal panel assembly rises, and, after a predetermined period has elapsed in the state where the voltage applied to the first liquid crystal panel assembly falls, the voltage applied to the second liquid crystal panel assembly falls. Thereby, the delay in the phase difference variation in the first liquid crystal panel assembly can be reliably compensated by the second liquid crystal panel assembly.

Also, it is preferable that a period when the phase difference in the first liquid crystal panel assembly increases to the maximum due to the fall in the applied voltage is longer than a period when the phase difference in the second liquid crystal panel assembly increases to the maximum due to the rise in the applied voltage. Thereby, it is possible to reliably compensate for the delay in the phase difference variation in the first liquid crystal panel assembly by the second liquid crystal panel assembly and to totally perform the phase difference variation at high speed by overlapping the first liquid crystal panel assembly with the second liquid crystal panel assembly.

Further, it is preferable that slow axes of the first liquid crystal panel assembly and the second liquid crystal panel assembly are substantially the same as each other and are substantially perpendicular to a slow axis of the optical compensation plate. Thereby, it is possible to reliably compensate for a remaining phase difference occurring in the first liquid crystal panel assembly or the second liquid crystal panel assembly using the optical compensation plate.

The first liquid crystal panel assembly may be an OCB type liquid crystal panel assembly, and the second liquid crystal panel assembly may be a VA type liquid crystal panel assembly. Due to this combination of the liquid crystal panel assemblies, it is possible to compensate for the slow phase difference variation occurring in the OCB type liquid crystal panel assembly during the fall in the applied voltage by the relatively fast phase difference variation during the rise in the VA type liquid crystal panel assembly, and to perform the phase difference variation in the liquid crystal device at high speed.

It is preferable that the optical compensation plate is formed to overlap with at least one of the pair of polarizers. Thereby, it is possible to reliably compensate for the remaining phase difference in the first liquid crystal panel assembly and/or the second liquid crystal panel assembly.

It is preferable that the optical compensation plate compensates for a remaining phase difference of transmitted light occurring during the period when the voltage applied to the first liquid crystal panel assembly rises. Thereby, it is possible to reliably compensate for the remaining phase difference even if the OCB type liquid crystal panel assembly is used as the first liquid crystal panel assembly.

It is preferable that the optical compensation plate is a uniaxial phase difference plate. Thereby, it is possible to compensate for the remaining phase difference simply and reliably in the liquid crystal panel assembly.

According to another aspect of the invention, there is provided a liquid crystal glasses including the two liquid crystal devices described above which are disposed in parallel, wherein one liquid crystal device is used as a right eye shutter and the other liquid crystal device is used as a left eye shutter, and wherein when an image display unit which alternately displays a right eye image and a left eye image is viewed in a time-divisional manner, the right eye shutter is opened and the left eye shutter is closed during a display period for the right eye image, and the right eye shutter is closed and the left eye shutter is opened during a display period for the left eye image.

According to the liquid crystal glasses, the first liquid crystal panel assembly in which the phase difference decreases due to the application of a voltage overlaps with the second liquid crystal panel assembly in which the phase difference increases due to the application of a voltage, the fact that the variation speed in the phase difference is larger during the rise in the applied voltage than during the fall in the applied voltage is used, and the rise in the voltage applied to the second liquid crystal panel assembly is overlapped with the fall in the voltage applied to the first liquid crystal panel assembly, thereby switching the right eye liquid crystal shutter and the left eye liquid crystal shutter from the closing state to the opening state at high speed. Thereby, it is possible to prevent the generation of so-called crosstalk in which a viewer views the right eye image and the left eye image together, and to clearly view three-dimensional images without blurring.

It is preferable that a receiving unit which receives timing signals generated so as to correspond to display changing between the right eye image and the left eye image is further provided. Thereby, the changing in the display images and the left and right shutters can be performed without being shifted.

It is preferable that when display changing between the right eye image and the left eye image is performed, the right eye shutter and the left eye shutter are simultaneously closed only during a predetermined period. Thereby, it is possible to more reliably prevent the generation of crosstalk in which a viewer views the right eye image and the left eye image together in a blurred state during the display changing between the left eye image and the right eye image.

### BRIEF DESCRIPTION OF THE DRAWINGS

The invention will be described with reference to the accompanying drawings, wherein like numbers reference like elements.

FIG. 1 is a schematic configuration diagram illustrating a liquid crystal shutter which is an example of a liquid crystal device according to an embodiment of the invention.

FIG. 2 is a diagram illustrating angle relationships between slow axes and transmission axes for the respective members constituting the liquid crystal shutter.

FIGS. 3A to 3C are diagrams illustrating a first liquid crystal panel assembly constituting the liquid crystal shutter.

FIGS. 4A to 4C are diagrams illustrating a second liquid crystal panel assembly constituting the liquid crystal shutter.

FIG. 5 is a diagram illustrating an operation of the liquid crystal shutter which is an example of the liquid crystal device according to an embodiment of the invention.

FIG. 6 is a schematic diagram illustrating a stereoscopic image viewing system using liquid crystal glasses.

FIG. 7 is an enlarged cross-sectional view illustrating the main parts of liquid crystal glasses provided with the liquid crystal device according to an embodiment of the invention.

FIG. 8 is a diagram illustrating an operation of the liquid crystal glasses according to an embodiment of the invention.

### DESCRIPTION OF EXEMPLARY EMBODIMENTS

Hereinafter, a liquid crystal device according to an embodiment of the invention will be described with reference to the accompanying drawings. Also, the embodiment is described in detail for better understanding of the invention, and thus does not limit the invention unless particularly designated otherwise. In the drawings used for the following description, in some cases, for convenience, the main parts are enlarged for better understanding of the features of the invention, and thus the dimensions or the like of the respective constituent elements may be different from actual ones.

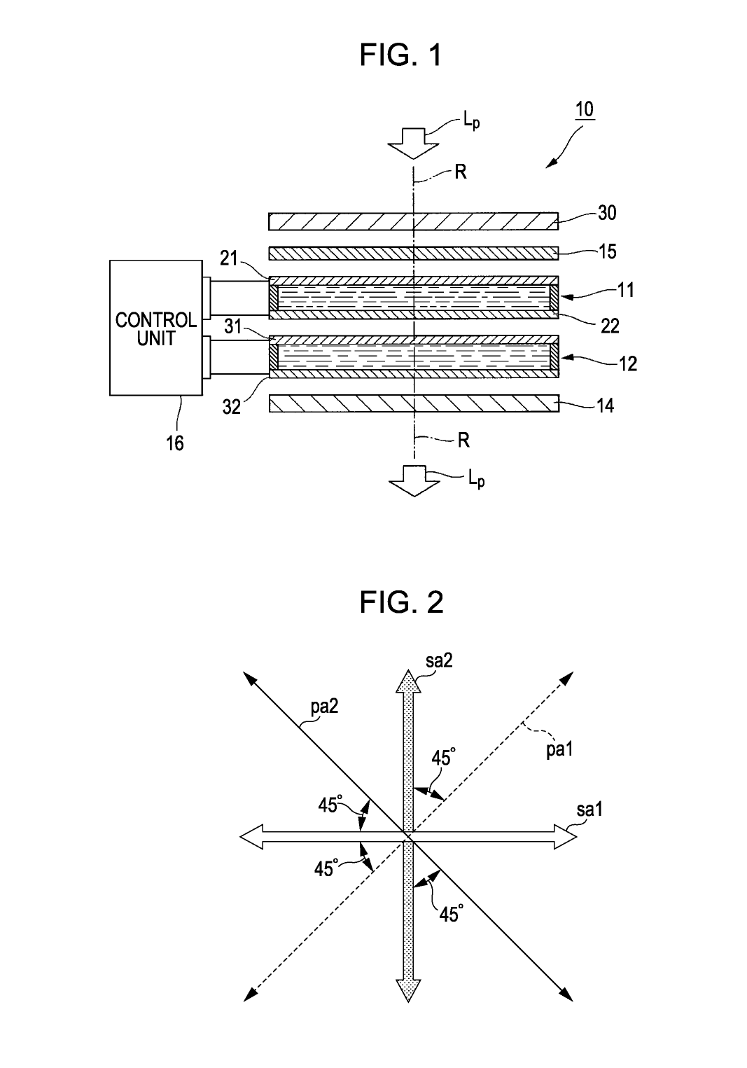

FIG. 1 is a configuration diagram illustrating an outline of a liquid crystal shutter which is an example of the liquid crystal device according to an embodiment of the invention.

A liquid crystal shutter (liquid crystal device) 10 is disposed, for example, in a light path R from an incidence side of light to an emission side thereof, and controls transmission and blocking of transmitted light Lp. Hereinafter, an opening state of the liquid crystal shutter 10 indicates a state where the transmitted light Lp is allowed to be transmitted, and a closing state indicates a state where the transmitted light Lp is hindered (blocked) from being transmitted.

The liquid crystal shutter (liquid crystal device) 10 includes a first liquid crystal panel assembly 11, a second liquid crystal panel assembly 12, and a first polarizer 13 and a second polarizer 14 forming a pair of polarizers interposed between the first liquid crystal panel assembly 11 and the second liquid crystal panel assembly 12. Further, an optical compensation plate 15 is provided between the first polarizer 13 and the first liquid crystal panel assembly 11. In addition, a control unit 16 which controls voltages applied to the first liquid crystal panel assembly 11 and the second liquid crystal panel assembly 12 is provided.

FIG. 2 is a schematic diagram illustrating angle relationships between slow axes and transmission axes of the respective constituent elements of the liquid crystal shutters (liquid crystal device) 10. FIG. 2 shows a state of being viewed from above with respect to an optical axis of the liquid crystal shutter 10.

The first liquid crystal panel assembly 11 and the second liquid crystal panel assembly 12 are disposed so as to correspond with the slow axes sa1 of each other. In addition, the optical compensation plate 15 is disposed such that the slow axis sa2 thereof is perpendicular to the slow axis sa1 of the first liquid crystal panel assembly 11 or the second liquid crystal panel assembly 12, at about 90°.

Further, the transmission axis pa1 of the first polarizer 13 and the transmission axis pa2 of the second polarizer 14 are disposed so as to be perpendicular to each other at about 90°, and the transmission axis pa1 of the first polarizer 13 or the transmission axis pa2 of the second polarizer 14 is disposed so as to intersect the slow axis sa1 of the first liquid crystal panel assembly 11 or the second liquid crystal panel assembly 12, and the slow axis sa2 of the optical compensation plate 15, at about 45°. In other words, the respective constituent elements are disposed such that the slow axis sa1 (the first liquid crystal panel assembly 11 and the second liquid crystal panel assembly 12), the slow axis sa2 (the optical compensation plate 15), the transmission axis pa1 (the first polarizer 13), and the transmission axis pa2 (the second polarizer 14) all intersect each other at about 45°.

In this embodiment, the optical compensation plate 15 is disposed between the first polarizer 13 and the first liquid crystal panel assembly 11, but the optical compensation plate may be disposed between the second liquid crystal panel assembly 12 and the second polarizer 14.

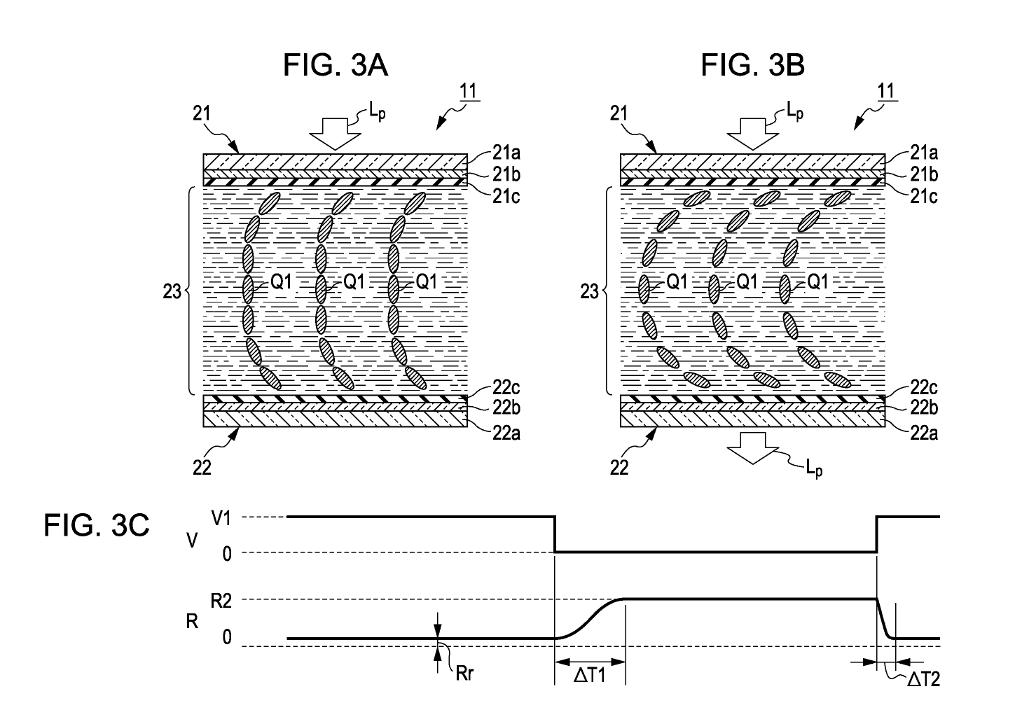

FIG. 3 is a diagram illustrating an example of the first liquid crystal panel assembly 11.

The first liquid crystal panel assembly 11 may use an OCB (Optical Compensated Bend) type liquid crystal device in which a phase difference decreases during the application of a voltage. The first liquid crystal panel assembly 11 includes an upper panel 21, a lower panel 22 (opposite panel) disposed opposite thereto, and a liquid crystal layer 23 interposed between the upper panel 21 and the lower panel 22.

The upper panel 21 has a substrate 21a which is a base made of a translucent material such as glass or quartz, an upper electrode 21b which is made of a transparent conductive material such as indium tin oxide (hereinafter, abbreviated to “ITO”) on one surface of the substrate 21a, and an alignment layer 21c made of silicon oxide or the like, which are sequentially laminated. The alignment layer 21c is rubbed in a predetermined direction.

In addition, the lower panel (opposite panel) 22 has a substrate 22a which is a base made of a translucent material such as glass or quartz, a lower electrode 22b of which the inside is made of a transparent conductive material such as ITO, and an alignment layer 22c made of silicon oxide, which are sequentially laminated. The alignment layer 22c is rubbed in a direction which is parallel to the rubbing direction in the alignment layer 21c and is reverse thereto. The liquid crystal layer 23 includes liquid crystals having a positive dielectric anisotropy.

In the first liquid crystal panel assembly 11 which is the OCB type liquid crystal device, in a state where a voltage of a predetermined value is applied between the upper electrode 21b and the lower electrode 22b, as shown in FIG. 3A, the curvature degree of the liquid crystal molecules Q1 forming the liquid crystal layer 23 becomes small, and thus the liquid crystal molecules are confined so as to be arranged in the thickness direction of the liquid crystal layer 23. In the state where the voltage is applied, the phase difference is minimal and thus the transmitted light Lp which comes from the upper panel 21 is blocked from being transmitted. Thereby, the first liquid crystal panel assembly 11 performs a black display (a state of blocking the transmitted light) in the voltage application state.

On the other hand, in a voltage non-application state where a voltage is not applied between the upper electrode 21b and the lower electrode 22b of the first liquid crystal panel assembly 11, as shown in FIG. 3B, the liquid crystal molecules forming the liquid crystal layer 23 are confined such that the alignment thereof is greatly curved between the upper and lower panels 21 and 22. In the voltage non-application state, the phase difference is maximal, and thus the transmitted light Lp which comes from the upper panel 21 is allowed to be transmitted, and a white display (a state of allowing the transmitted light to be transmitted) is performed.

FIG. 3C is a graph illustrating a relationship between the applied voltage V and the phase difference R in the first liquid crystal panel assembly 11. In the first liquid crystal panel assembly 11, if a voltage V1 of a predetermined value is applied between the upper electrode 21b and the lower electrode 22b, the phase difference (retardation) in the first liquid crystal panel assembly 11 becomes a phase difference R1 close to 0. A slightly remaining phase difference during the application of the voltage is a remaining phase difference Rr and occurs due to the characteristics of the OCB type liquid crystal. The optical compensation plate 15 (refer to FIG. 1) disposed between the first polarizer 13 and the first liquid crystal panel assembly 11 optically compensates for the remaining phase difference Rr. The optical compensation plate 15 may use a uniaxial phase difference plate along the slow axis, for example, a C plate.

Next, if the applied voltage V between the upper electrode 21b and the lower electrode 22b falls, that is, the applied voltage is changed from V1 to 0 (voltage non-application state), the phase difference (retardation) in the first liquid crystal panel assembly 11 is expanded to a predetermined phase difference R2. At this time, the phase difference smoothly varies to R2 for a predetermined delay time ΔT1. This is because the delay in the phase difference variation is great during the fall in the applied voltage, which is a typical characteristic of the liquid crystal.

If the applied voltage V between the upper electrode 21b and the lower electrode 22b rises again, that is, is changed to V1, the phase difference (retardation) in the first liquid crystal panel assembly 11 falls again, leaving the remaining phase difference Rr. At this time, the phase difference is changed from the phase difference R2 to the phase difference R1 for a predetermined delay time ΔT2, and the delay time ΔT2 in the phase difference variation during the rise in the applied voltage is shorter than the delay time ΔT1 in the phase difference variation during the fall in the applied voltage V. This results from a typical characteristic of the liquid crystal that the delay time ΔT2 in the phase difference variation during the rise in the applied voltage V is shorter than the delay time ΔT1 in the phase difference variation during the fall in the applied voltage.

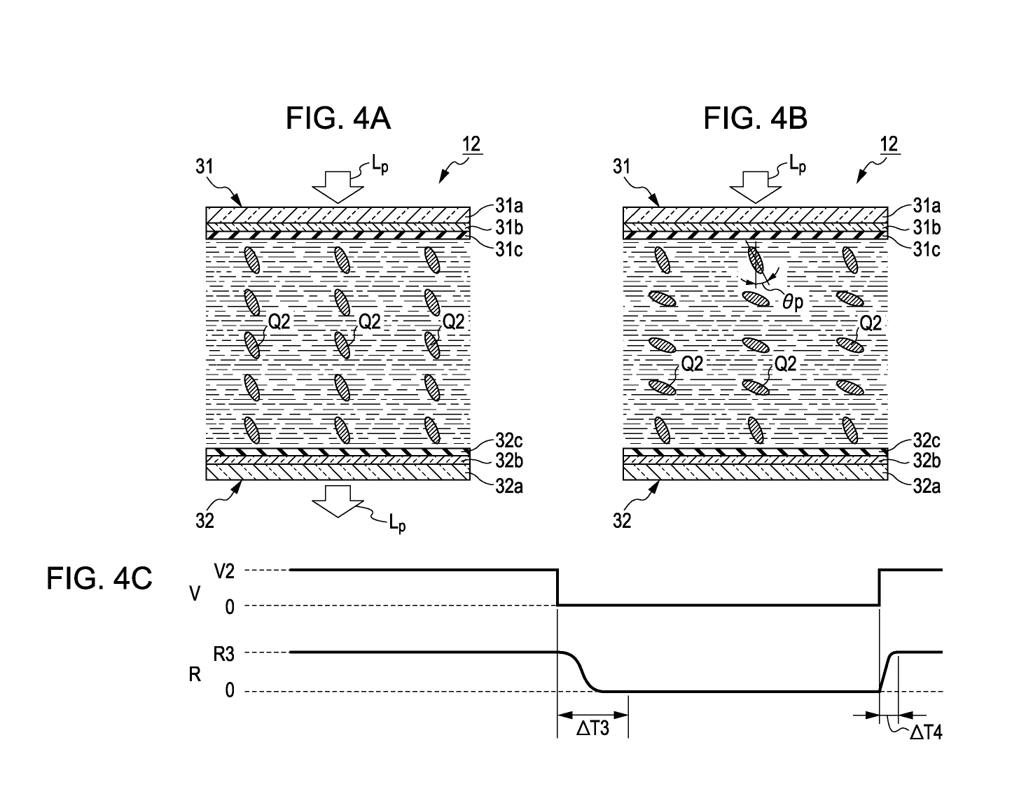

FIGS. 4A to 4C are diagrams illustrating an example of the second liquid crystal panel assembly 12.

The second liquid crystal panel assembly 12 may use a VA (Vertical Alignment Nematic) type liquid crystal device in which the phase difference increases during the application of a voltage. The second liquid crystal panel assembly 12 includes an upper panel 31, a lower panel 32 (opposite panel) disposed opposite thereto, and a liquid crystal layer 33 interposed between the upper panel 31 and the lower panel 32.

The upper panel 31 includes a substrate 31a which is a base made of a transparent substrate such as, for example, glass, quartz, or plastic, and the transmitted light Lp which is transmitted through the first liquid crystal panel assembly 11 shown in FIG. 2 is incident from an outer surface of the upper panel 31, passes through a liquid crystal layer 33, and then is emitted from an outer surface of a lower panel 32.

An upper electrode 31b made of a transparent conductive film such as ITO is formed on the inside of the substrate 31a. A vertical alignment layer 31c (hereinafter, referred to as a “tilt vertical alignment layer”) which causes liquid crystal molecules Q2 of a liquid crystal layer 33 to be pre-tilted is formed on the upper electrode 31b in an overlapping manner.

The lower panel 32 includes a substrate 32a which is a base made of a transparent substrate such as, for example, glass, quartz, or plastic, and a lower electrode (opposite electrode) 32b made of a transparent conductive film such as ITO is formed on the inside of the lower panel. A vertical alignment layer 32c (hereinafter, referred to as a “tilt vertical alignment layer”) which causes liquid crystal molecules Q2 of the liquid crystal layer 33 to be pre-tilted is formed on the upper electrode 32b in an overlapping manner.

Vertical alignment layers are formed by applying and firing a material for the vertical alignment layer such as, for example, a polyamic acid material, and then the tilt vertical alignment layers 31c and 32c are formed through the rubbing process. Alternatively, they may be formed by irradiating vertical alignment layers with polarization UV beams in a tilted direction, by forming vertical alignment layers on an SiO oblique deposition layer, or by obliquely depositing inorganic compounds such as SiO, SiO₂, or MgF₂.

The liquid crystal layer 33 includes negative dielectric anisotropy liquid crystal, and, the pre-tilt angle (θp) of the tilt vertical alignment layers 31c and 32c is set to 2°. In addition, an angle where a director of the liquid crystal molecule is formed with respect to the normal direction of the substrate surface is the pre-tilt angle.

In the VA type second liquid crystal panel assembly 12, in a voltage application state where a voltage of a predetermined value is applied between the upper electrode 31b and the lower electrode 32b, as shown in FIG. 4A, the liquid crystal molecules Q2 are vertically aligned with the pre-tilt angle of θp=2° from the tilt vertical alignment layer 31c of the upper panel 31 to the tilt vertical alignment layer 32c of the lower panel 32.

On the other hand, in a voltage non-application state where a voltage is not applied between the upper electrode 31b and the lower electrode 32b, as shown in FIG. 4B, the liquid crystal molecules Q2 in the tilt vertical alignment layer 31c side of the upper panel 31 and the tilt vertical alignment layer 32c side of the lower panel 32 have the pre-tilt angle of θp=2° and the liquid crystal molecules Q2 between them are tilted nearly in the horizontal direction in terms of the angle of orientation.

FIG. 4C is a graph illustrating a relationship between the applied voltage V and the phase difference R in the second liquid crystal panel assembly 12. In the second liquid crystal panel assembly 12, when the voltage V2 of a predetermined value is applied between the upper electrode 31b and the lower electrode 32b, the phase difference (retardation) in the second liquid crystal panel assembly 12 is expanded to a predetermined phase difference R3.

Next, if the applied voltage V between the upper electrode 31b and the lower electrode 32b falls, that is, the applied voltage is changed from V2 to 0 (voltage non-application state), the phase difference (retardation) in the second liquid crystal panel assembly 12 becomes 0. At this time, the phase difference smoothly varies to 0 for a predetermined delay time ΔT3. This is because the delay in the phase difference variation is great during the fall in the applied voltage, which is a typical characteristic of the liquid crystal.

If the applied voltage V between the upper electrode 31b and the lower electrode 32b rises again, that is, is changed to V2, the phase difference in the second liquid crystal panel assembly 12 is expanded to the predetermined phase difference R3. At this time, the phase difference is changed to the phase difference R3 for a predetermined delay time ΔT4, and the delay time ΔT4 in the phase difference variation during the rise in the applied voltage is shorter than the delay time ΔT3 in the phase difference variation during the fall in the applied voltage V. This results from a typical characteristic of the liquid crystal that the delay time ΔT4 in the phase difference variation during the rise in the applied voltage V is shorter than the delay time ΔT3 in the phase difference variation during the fall in the applied voltage.

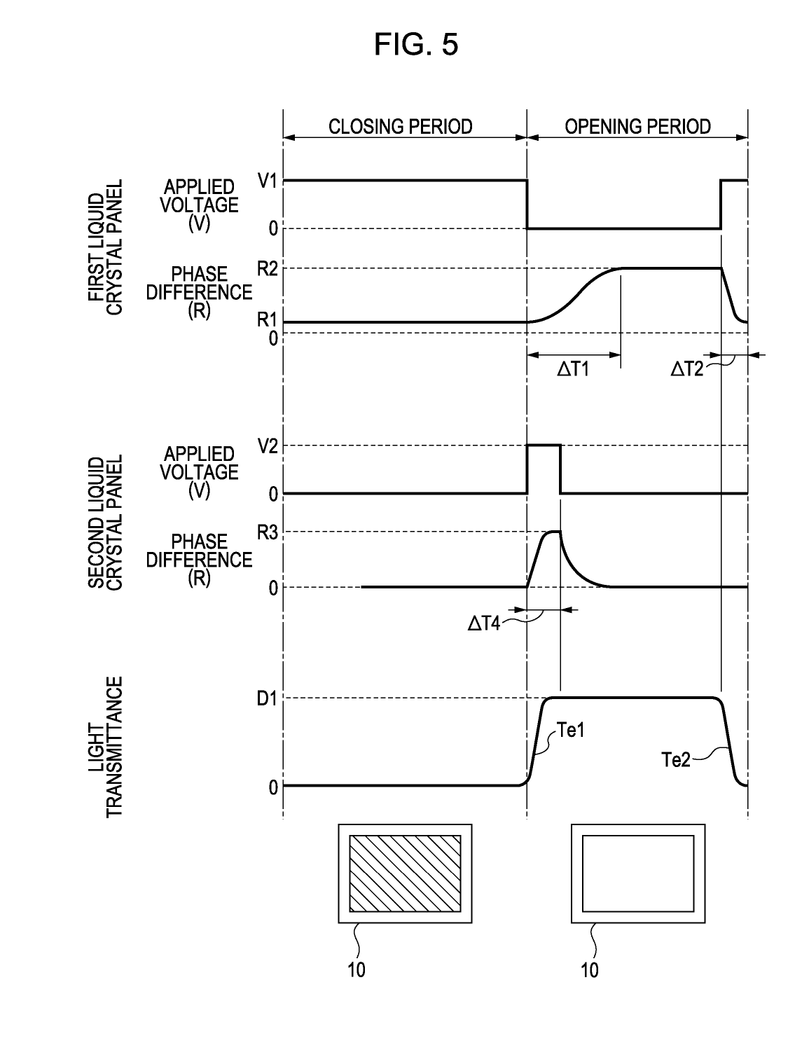

An operation of the liquid crystal shutters (liquid crystal device) 10 according to an embodiment of the invention configured in this way will be described with reference to FIGS. 1 and 5. FIG. 5 is a diagram illustrating an operation of the liquid crystal shutters.

The liquid crystal shutter (liquid crystal device) 10 may have two states, that is, an opening state of allowing the transmitted light Lp to be transmitted and a closing state of blocking the transmitted light Lp from being transmitted, and, thereby, plays a part of a shutter for the transmitted light. In FIG. 5, an opening period indicates a period when the liquid crystal shutter 10 is in the opening state and a closing period indicates a period when the liquid crystal shutter 10 is in the closing state.

In FIG. 5, during the closing period in the liquid crystal shutter 10, a predetermined voltage V1 is applied to the first liquid crystal panel assembly 11. Thereby, the phase difference in the first liquid crystal panel assembly 11 becomes the phase difference R1 close to 0. The remaining phase difference Rr in the phase difference R1 and the phase difference 0 is compensated by the optical compensation plate 15, and thus the phase difference in the liquid crystal shutter 10 during the closing period becomes substantially 0.

On the other hand, during the closing period in the liquid crystal shutter 10, a voltage is not applied to the second liquid crystal panel assembly 12 (voltage 0). The second liquid crystal panel assembly 12 becomes 0 in the phase difference in the voltage non-application state.

As a result, the transmittance of light in the liquid crystal shutter 10 in which the first liquid crystal panel assembly 11 overlaps with the second liquid crystal panel assembly 12 becomes T0, that is, the liquid crystal shutter 10 enters the state of blocking the transmitted light.

Next, in order to change the state from the closing state to the opening state, the applied voltage becomes 0 by decreasing the voltage applied to the first liquid crystal panel assembly 11. At the same time, the voltage applied to the second liquid crystal panel assembly 12 rises so as to become the predetermined applied voltage V2. Thereby, the phase difference in the first liquid crystal panel assembly 11 smoothly increases from R1 to R2. In addition, the phase difference in the second liquid crystal panel assembly 12 also increases from 0 to R3.

As a result, during the opening period in the liquid crystal shutter 10, the transmittance of light in the liquid crystal shutter 10 in which the first liquid crystal panel assembly 11 overlaps with the second liquid crystal panel assembly 12 increases to a predetermined D1, and the liquid crystal shutter 10 enters the state of transmitting the transmitted light.

When the liquid crystal shutter 10 is switched from the closing state to the opening state, the phase difference increases due to the fall in a voltage applied to the first liquid crystal panel assembly 11 and the phase difference increases due to the rise in a voltage applied to the second liquid crystal panel assembly 12, thereby rapidly changing the transmittance of the liquid crystal shutter 10. As a result, the variation in the transmittance when the liquid crystal shutter 10 is switched to the opening state becomes steep (refer to the line Te1 in FIG. 5).

In other words, the phase difference in the liquid crystal varies during the rise in the applied voltage faster than during the fall in the applied voltage. By using this, in order to compensate for the operation delay of the first liquid crystal panel assembly 11 in which the phase difference smoothly varies from R1 to R2 for the long delay time ΔT1 when the applied voltage falls, the second liquid crystal panel assembly 12 is used in which the phase difference is changed from 0 to R3 for a relatively short (much shorter than the delay time ΔT1) delay time ΔT4 when the applied voltage rises.

Thereby, it is possible to rapidly change the light transmittance from 0 to D1 by overlapping the fall in a voltage applied to the second liquid crystal panel assembly 12 when a voltage applied to the first liquid crystal panel assembly 11 falls.

When the liquid crystal shutter 10 is switched from the opening state to the closing state again, the phase difference decreases to R1 by increasing a voltage applied to the first liquid crystal panel assembly 11. In addition, a voltage applied to the second liquid crystal panel assembly 12 may fall after the phase difference in the second liquid crystal panel assembly 12 is changed to the predetermined phase difference R3 (after the delay time ΔT4 has elapsed) or after the phase difference in the first liquid crystal panel assembly 11 is changed to the phase difference R2 (after the delay time ΔT1 has elapsed). In other words, the voltage applied to the second liquid crystal panel assembly 12 may fall after a predetermined time has elapsed, in a state where the voltage applied to the first liquid crystal panel assembly 11 falls.

When the liquid crystal shutter 10 is switched to the closing state, since the rise in the voltage applied to the first liquid crystal panel assembly 11 is used, the phase difference can decrease from R2 to R1 for a relatively short (much shorter than the delay time ΔT1) delay time ΔT2. Therefore, when the liquid crystal shutter 10 is switched to the closing state as well, the transmittance can steeply vary (refer to the line Te2 in FIG. 5).

As described above, in the liquid crystal shutters (liquid crystal device) 10 according to an embodiment of the invention, the first liquid crystal panel assembly 11 in which the phase difference decreases due to the application of a voltage overlaps with the second liquid crystal panel assembly 12 in which the phase difference increases due to the application of a voltage, the fact that the variation speed in the phase difference is larger during the rise in the applied voltage than during the fall in the applied voltage is used, and the rise in the voltage applied to the second liquid crystal panel assembly 12 is overlapped with the fall in the voltage applied to the first liquid crystal panel assembly 11, thereby switching the liquid crystal shutter 10 from the closing state to the opening state in a short time. Therefore, it is possible to implement the high speed liquid crystal shutter with a relatively simple configuration.

Next, liquid crystal glasses using the above-described liquid crystal shutters (liquid crystal device) according to an embodiment of the invention will be described.

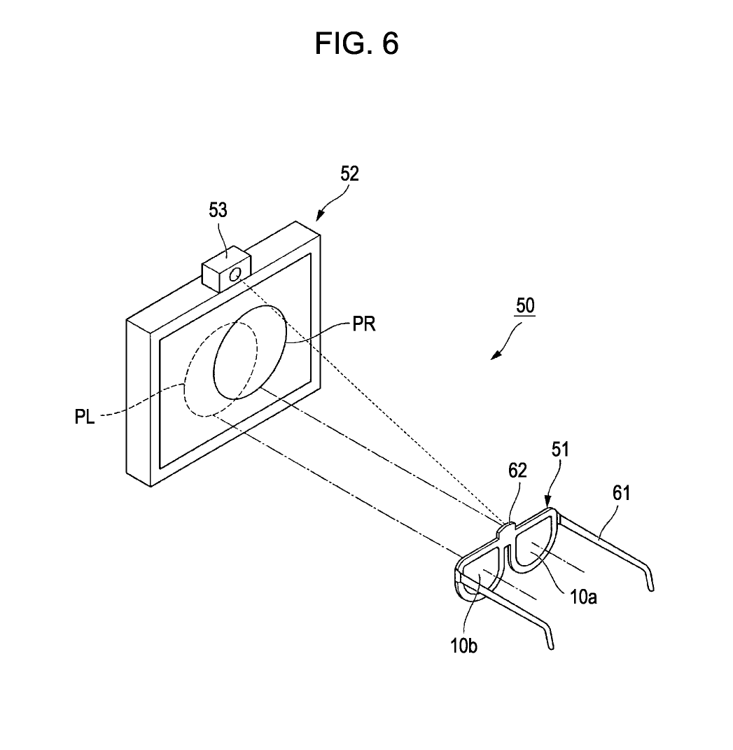

FIG. 6 is a schematic diagram illustrating a stereoscopic image viewing system using liquid crystal glasses. The stereoscopic image viewing system 50 includes liquid crystal glasses 51 and a stereoscopic image display device 52. The stereoscopic image display device 52 alternately displays a right eye image PR and a left eye image PL which are misaligned with a distance corresponding to the parallax W of the right eye and the left eye of a viewer (human being) at predetermined timings. The stereoscopic image display device 52 is provided with a timing signal generator 53 which generates signals in synchronization with the changing timing between the right eye image PR and the left eye image PL.

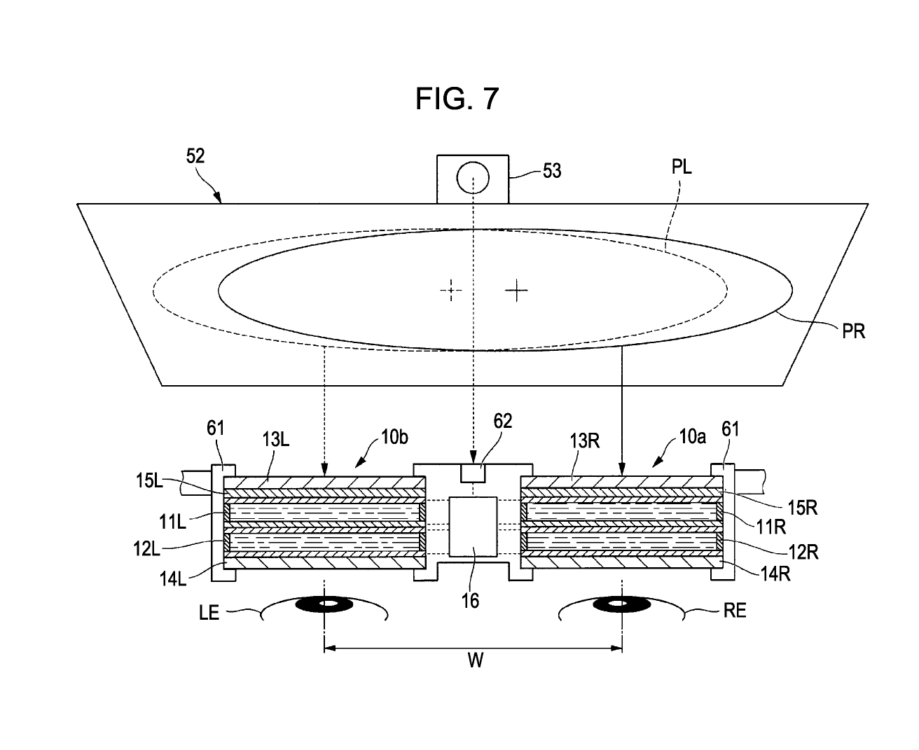

FIG. 7 is an enlarged cross-sectional view illustrating the main parts of the liquid crystal glasses.

The liquid crystal glasses 51 include the above-described two liquid crystal shutters (liquid crystal devices) 10 which are disposed in parallel and a glasses frame 61 supporting the two liquid crystal shutters 10a and 10b. Among them, the liquid crystal shutter 10a is positioned in the line of sight for the right eye RE of the viewer, and the liquid crystal shutter 10b is positioned in the line of sight for the left eye LE (hereinafter, respectively also referred to as a right eye shutter and a left eye shutter). Further, the glasses frame 61 is provided with a timing signal receiving unit 62 which receives timing signals generated from the timing signal generator 53.

The right eye liquid crystal shutter 10a includes a first liquid crystal panel assembly 11R, a second liquid crystal panel assembly 12R, and a first polarizer 13R and a second polarizer 14R forming a pair of polarizers which is interposed between the first liquid crystal panel assembly 11R and the second liquid crystal panel assembly 12R. In addition, an optical compensation plate 15R is provided between the first polarizer 13R and the first liquid crystal panel assembly 11R.

In the same manner, the left eye liquid crystal shutter 10b includes a first liquid crystal panel assembly 11L, a second liquid crystal panel assembly 12L, and a first polarizer 13L and a second polarizer 14L forming a pair of polarizers which is interposed between the first liquid crystal panel assembly 11L and the second liquid crystal panel assembly 12L. In addition, an optical compensation plate 15L is provided between the first polarizer 13L and the first liquid crystal panel assembly 11L.

A control unit 16, which collectively applies voltages to the first liquid crystal panel assembly 11R and the second liquid crystal panel assembly 12R constituting the right eye liquid crystal shutter 10a and the first liquid crystal panel assembly 11L and the second liquid crystal panel assembly 12L constituting the left eye liquid crystal shutter 10b, is provided in the glasses frame 61. The control unit 16 is supplied with a signal received by the timing signal receiving unit 62.

The first liquid crystal panel assembly 11L and the first liquid crystal panel assembly 11R may be an OCB type liquid crystal device in which the phase difference decreases during the application of a voltage in the same manner as the first liquid crystal panel assembly 11 in the above-described embodiment. In addition, the second liquid crystal panel assembly 12L and the second liquid crystal panel assembly 12R may be a VA type liquid crystal device in which the phase difference increases during the application of a voltage in the same manner as the second liquid crystal panel assembly 12 in the above-described embodiment.

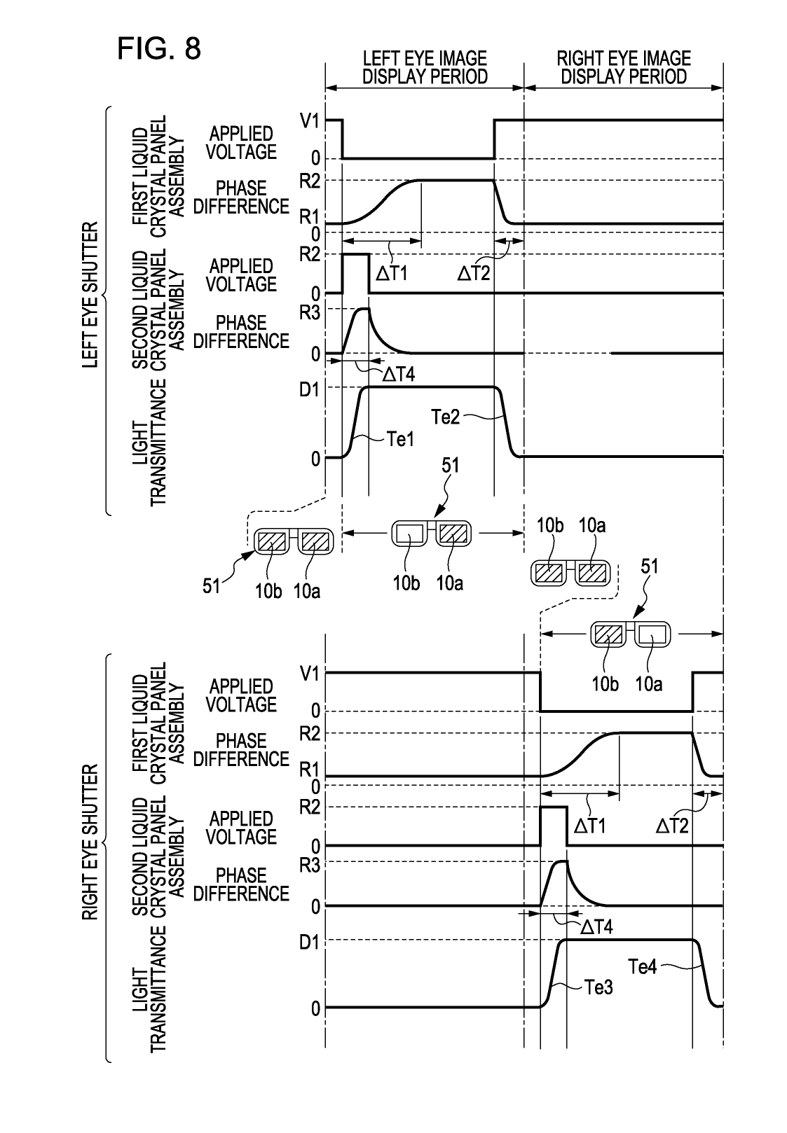

An operation of the liquid crystal glasses 51 configured as described above will be described with reference to FIGS. 7 and 8. FIG. 8 is a diagram illustrating a shutter operation of the liquid crystal glasses.

The liquid crystal glasses 51 open the left eye liquid crystal shutter 10b and close the right eye liquid crystal shutter 10a during the left eye image display period when the left eye image PL is displayed in the stereoscopic image display device 52. In addition, the liquid crystal glasses 51 open the right eye liquid crystal shutter 10a and close the left eye liquid crystal shutter 10b during the right eye image display period when the right eye image PR is displayed in the stereoscopic image display device 52.

In this way, the liquid crystal glasses 51 alternately change between the opening and the closing of the liquid crystal shutters for the right eye and left eye during the left eye image display period and the right eye image display period. The changing between the opening and the closing of the liquid crystal shutter 10a and the liquid crystal shutter 10b is performed by the input signal received by the timing signal receiving unit 62.

In other words, in the stereoscopic image display device 52, the timing signal generator 53 generates timing signals when the display is changed from the left eye image PL to the right eye image PR and when the display is changed from the right eye image PR to the left eye image PL. The timing signal receiving unit 62 of the liquid crystal glasses 51 outputs the received timing signals to the control unit 16 if the timing signals are generated. The control unit 16 respectively controls voltages applied to the first liquid crystal panel assembly 11R and the second liquid crystal panel assembly 12R constituting the right eye liquid crystal shutter 10a and the first liquid crystal panel assembly 11L and the second liquid crystal panel assembly 12L constituting the left eye liquid crystal shutter 10b, based on the input of the received signal.

As shown in FIG. 8, when the stereoscopic image display device 52 enters the left eye image display period, the liquid crystal glasses 51 are switched to the opening state of the left eye liquid crystal shutter 10b. First, a voltage applied to the first liquid crystal panel assembly 11L falls to 0. At the same time, a voltage applied to the second liquid crystal panel assembly 12L rises to a predetermined voltage V2. Thereby, the phase difference in the first liquid crystal panel assembly 11L smoothly increases from R1 to R2. In addition, the phase difference in the second liquid crystal panel assembly 12L also increases from 0 to R3.

Therefore, the light transmittance in the left eye liquid crystal shutter 10b in which the first liquid crystal panel assembly 11L and the second liquid crystal panel assembly 12L overlap with each other increases to a predetermined D1, thus the left eye liquid crystal shutter 10b enters an opening state of transmitting image light for the left eye image PL, and thereby the left eye LE of the viewer can recognize the left eye image PL.

When the liquid crystal shutter 10b is switched from the closing state to the opening state, the phase difference increases due to the fall in a voltage applied to the first liquid crystal panel assembly 11L and the phase difference increases due to the rise in a voltage applied to the second liquid crystal panel assembly 12L, thereby rapidly changing the transmittance of the liquid crystal shutter 10b. As a result, the variation in the transmittance when the liquid crystal shutter 10b is switched to the opening state becomes steep (refer to the line Te1 in FIG. 8).

In other words, the phase difference in the liquid crystal varies during the rise in the applied voltage faster than during the fall in the applied voltage. By using this, in order to compensate for the operation delay of the first liquid crystal panel assembly 11L in which the phase difference smoothly varies from R1 to R2 for the long delay time ΔT1 when the applied voltage falls, the second liquid crystal panel assembly 12L is used in which the phase difference is changed from 0 to R3 for a relatively short (much shorter than the delay time ΔT1) delay time ΔT4 when the applied voltage rises.

Thereby, it is possible to rapidly change the light transmittance from 0 to D1 by overlapping the fall in a voltage applied to the second liquid crystal panel assembly 12L when a voltage applied to the first liquid crystal panel assembly 11L falls, and to change the left eye liquid crystal shutter 10b from the closing state to the opening state at high speed. In addition, the voltage V2 applied to the second liquid crystal panel assembly 12L may fall after the phase difference in the second liquid crystal panel assembly 12L reaches the predetermined R3 (after the delay time ΔT4 has elapsed).

On the other hand, the right eye liquid crystal shutter 10a is switched to the closing state before the stereoscopic image display device 52 enters the left eye image display period. In other words, the voltage applied to the first liquid crystal panel assembly 11R rises to the predetermined V1 and simultaneously the voltage applied to the second liquid crystal panel assembly 12R falls to 0. Thereby, in the right eye liquid crystal shutter 10a, the light transmittance in the liquid crystal shutter 10a in which the first liquid crystal panel assembly 11R and the second liquid crystal panel assembly 12R overlap with each other becomes 0. Therefore, the right eye liquid crystal shutter 10a enters the closing state of blocking the image light for the left eye image PL, and thus the right eye RE of the viewer does not recognize the left eye image PL.

After the left eye image display period has elapsed, the liquid crystal glasses 51 switch the left eye liquid crystal shutter 10b to the closing state. In other words, the voltage applied to the first liquid crystal panel assembly 11L rises to the voltage V1. Thereby, the phase difference in the first liquid crystal panel assembly 11L decreases to R1. When the left eye liquid crystal shutter 10b is switched to the closing state, since the rise in the voltage applied to the first liquid crystal panel assembly 11 is used, the phase difference can decrease from R2 to R1 for a relatively short (much shorter than the delay time ΔT1) delay time ΔT2. Therefore, when the left eye liquid crystal shutter 10b is switched to the closing state as well, the transmittance can steeply vary (refer to the line Te2 in FIG. 8). In addition, the remaining phase difference Rr in the phase difference R1 and the phase difference 0 becomes substantially 0 through the compensation by the optical compensation plate 15L.

If the right eye image display period starts after the left eye image display period is finished, at this time, the right eye liquid crystal shutter 10a is switched to the opening state while the left eye liquid crystal shutter 10b is maintained to be in the closing state, but, both of the liquid crystal shutters 10a and 10b are in the closing state during a predetermined period at that time.

That is to say, at the time of changing between the left eye image display and the right eye image display, the viewer is prevented from viewing both the left eye image and the right eye image by maintaining both the liquid crystal shutters 10a and 10b in the closing state for a short time. Since the human eye has after-images, if the right eye image is displayed immediately after the left eye image disappears, both the left eye image and the right eye image are seen in a blurred state (crosstalk) since the left eye image remains. When the changing between the left eye image display and the right eye image display is performed, both the liquid crystal shutters 10a and 10b are maintained to be in the closing state for a short time, thereby preventing this crosstalk.

If the right eye image display period starts, the voltage applied to the first liquid crystal panel assembly 11R falls to 0 at this time. At the same time, the voltage applied to the second liquid crystal panel assembly 12R rises to the predetermined voltage V2. Thereby, the phase difference in the first liquid crystal panel assembly 11R smoothly increases from R1 to R2. In addition, the phase difference in the second liquid crystal panel assembly 12R increases from 0 to R3.

Therefore, the light transmittance in the liquid crystal shutter 10a in which the first liquid crystal panel assembly 11R and the second liquid crystal panel assembly 12R overlap with each other increases to a predetermined D1, thus the right eye liquid crystal shutter 10a enters the opening state of transmitting image light for the right eye image PR, and thereby the right eye RE of the viewer can recognize the right eye image PR.

When the liquid crystal shutter 10a is switched from the closing state to the opening state, the phase difference increases due to the fall in a voltage applied to the first liquid crystal panel assembly 11R and the phase difference increases due to the rise in a voltage applied to the second liquid crystal panel assembly 12R, thereby rapidly changing the transmittance of the liquid crystal shutter 10a. As a result, the variation in the transmittance when the liquid crystal shutter 10a is switched to the opening state becomes steep (refer to the line Te3 in FIG. 8).

Thereby, it is possible to rapidly change the light transmittance of the liquid crystal shutter 10a from 0 to D1 by overlapping the fall in a voltage applied to the second liquid crystal panel assembly 12R when a voltage applied to the first liquid crystal panel assembly 11R falls, and to change the right eye liquid crystal shutter 10a from the closing state to the opening state at high speed. In addition, the left eye liquid crystal shutter 10b is switched to the closing state before the stereoscopic image display device 52 enters the left eye image display period, and thus the left eye LE of the viewer does not recognize the right eye image PR.

After the right eye image display period has elapsed, the liquid crystal glasses 51 switch the right eye liquid crystal shutter 10a to the closing state. In other words, the voltage applied to the first liquid crystal panel assembly 11R rises to the voltage V1. Thereby, the phase difference in the first liquid crystal panel assembly 11R decreases to R1. When the right eye liquid crystal shutter 10a is switched to the closing state, since the rise in the voltage applied to the first liquid crystal panel assembly 11R is used, the phase difference can decrease from R2 to R1 for a relatively short (much shorter than the delay time ΔT1) delay time ΔT2. Therefore, when the right eye liquid crystal shutter 10a is switched to the closing state as well, the transmittance can steeply vary (refer to the line Te4 in FIG. 8).

Next, if the left eye image display period starts, both the liquid crystal shutters 10a and 10b are maintained to be in the closing state again during a predetermined period, and the liquid crystal shutter 10b is switched to the opening state from the closing state through the above-described process.

As described above, in the liquid crystal glasses according to the embodiment of the invention, the first liquid crystal panels 11L and 11R in which the phase difference decreases due to the application of a voltage overlaps with the second liquid crystal panels 12L and 12R in which the phase difference increases due to the application of a voltage, the fact that the variation speed in the phase difference is larger during the rise in the applied voltage than during the fall in the applied voltage is used, and the rise in the voltage applied to the second liquid crystal panel assemblies 12L and 12R is overlapped with the fall in the voltage applied to the first liquid crystal panel assemblies 11L and 11R, thereby it is possible to switch the right eye liquid crystal shutter 10a and the left eye liquid crystal shutter 10b from the closing state to the opening state at high speed. Therefore, it is possible to prevent the generation of so-called crosstalk in which a viewer views the right eye image and the left eye image together, and to clearly view three-dimensional stereoscopic images without blurring.

The entire disclosure of Japanese Patent Application No. 2010-053630, filed Mar. 10, 2010 is expressly incorporated by reference herein.

What is claimed is:

1. A method of operating a liquid crystal device, comprising:
decreasing a phase difference due to application of a voltage in a first liquid crystal panel assembly;
increasing the phase difference due to application of a voltage in a second liquid crystal panel assembly that is formed to overlap with the first liquid crystal panel assembly, wherein the first liquid crystal panel assembly and the second liquid crystal panel assembly are between a pair of polarizers, and wherein an optical compensation plate is formed to overlap with at least one of the pair of polarizers;
controlling the voltages applied to the first liquid crystal panel assembly and the second liquid crystal panel assembly by a control unit, the control unit independently controlling the voltages applied to the first liquid crystal panel assembly and the second liquid crystal panel assembly; and
performing, with the control unit, a control such that the voltage applied to the first liquid crystal panel assembly falls and simultaneously the voltage applied to the second liquid crystal panel assembly rises, and such that after a predetermined period has elapsed in the state where the voltage applied to the first liquid crystal panel assembly falls, the voltage applied to the second liquid crystal panel assembly falls.

2. The method of claim 1, wherein the method includes a period when the phase difference in the first liquid crystal panel assembly increases to the maximum due to the falling in the applied voltage that is longer than a period when the phase difference in the second liquid crystal panel assembly increases to the maximum due to the rise in the applied voltage.

3. The method of claim 1, wherein the method is executed when a slow axes of the first liquid crystal panel assembly and the second liquid crystal panel assembly are substantially the same as each other and are substantially perpendicular to a slow axis of the optical compensation plate.

4. The method of claim 1, wherein the first liquid crystal panel assembly is an OCB (Optical Compensated Bend) type liquid crystal panel assembly, and the second liquid crystal panel assembly is a VA (Vertical Alignment Nematic) type liquid crystal panel assembly.

5. The method of claim 1, wherein the optical compensation plate is formed to overlap with at least one of the pair of polarizers.

6. The method of claim 5, further comprising compensating, with the optical compensation plate, for a remaining phase difference of transmitted light occurring during the period when the voltage applied to the first liquid crystal panel assembly rises.

7. The method of claim 5, wherein the optical compensation plate is a uniaxial phase difference plate.

8. A method of operating a liquid crystal device, comprising:
controlling, with a control unit, a first liquid crystal panel and a second liquid crystal panel that opposes to the first liquid crystal panel, wherein the first liquid crystal panel and the second liquid crystal panel are disposed between a first polarizer and a second polarizer, and wherein an optical compensation plate overlaps at least one of the first polarizer and the second polarizer when viewed from the first polarizer toward the second polarizer;
controlling, with the control unit, a first phase difference that is a phase difference of incident light and transparent light of the first liquid crystal panel;
controlling, with the control unit, a second phase difference that is a phase difference of incident light and transparent light of the second liquid crystal panel; and
increasing the first phase difference and the second phase difference by changing with the control unit the first phase difference and the second phase difference at a first time.

9. The method of claim 8, the method further comprising decreasing the first phase difference by changing, with the control unit, the first phase difference at a second time, wherein a predetermined period is between the second time and the first time.

10. The method of claim 8, wherein the first liquid crystal panel is an OCB (Optical Compensated Bend) type, and the second liquid crystal panel is a VA (Vertical Alignment Nematic) type.

11. A method, comprising:
executing, in liquid crystal glasses including two liquid crystal devices disposed in parallel, the following actions in both of the liquid crystal devices:
decreasing a phase difference due to application of a voltage in a first liquid crystal panel assembly;
increasing the phase difference due to application of a voltage in a second liquid crystal panel assembly that is formed to overlap with the first liquid crystal panel assembly, wherein the first liquid crystal panel assembly and the second liquid crystal panel assembly are between a pair of polarizers, and wherein an optical compensation plate is formed to overlap with at least one of the pair of polarizers;
controlling the voltages applied to the first liquid crystal panel assembly and the second liquid crystal panel assembly by a control unit, the control unit independently controlling the voltages applied to the first liquid crystal panel assembly and the second liquid crystal panel assembly,
wherein one liquid crystal device is used as a right eye shutter and the other liquid crystal device is used as a left eye shutter; and
wherein when an image display unit which alternately displays a right eye image and a left eye image in a time-divisional manner is viewed, the right eye shutter is opened and the left eye shutter is closed during a display period for the right eye image, and the right eye shutter is closed and the left eye shutter is opened during a display period for the left eye image.

12. The method of claim 11, further comprising receiving, with a receiving unit, timing signals generated so as to correspond to display changing between the right eye image and the left eye image.

13. The method of claim 11, wherein when display changing between the right eye image and the left eye image is performed, the right eye shutter and the left eye shutter are simultaneously closed only during a predetermined period.

14. The method of claim 11, further comprising:
viewing an image display unit which alternately displays a right eye image and a left eye image in a time-divisional manner such that the right eye shutter is opened and the left eye shutter is closed during a display period for the right eye image, and the right eye shutter is closed and the left eye shutter is opened during a display period for the left eye image.

15. The method of claim 14, further comprising:
changing display between the right eye image and the left eye image such that the right eye shutter and the left eye shutter are simultaneously closed only during a predetermined period.

16. A method, comprising:
alternately displaying a right eye image and a left eye image with a stereoscopic image display device;
generating a timing signal, with a timing signal generator, corresponding to changing timing between the right eye image and the left eye image;
executing the method of claim 11; and
receiving, with a timing signal receiving unit of the liquid crystal glasses, the timing signal generated from the timing signal generator.

17. The method of claim 11, further comprising:
executing, in liquid crystal glasses, the following actions in both of the liquid crystal devices:
performing, with the control unit, a control such that the voltage applied to the first liquid crystal panel assembly falls and simultaneously the voltage applied to the second liquid crystal panel assembly rises, and such that after a predetermined period has elapsed in the state where the voltage applied to the first liquid crystal panel assembly falls, the voltage applied to the second liquid crystal panel assembly falls.

18. The method of claim 16, further comprising:
executing, in liquid crystal glasses, the following actions in both of the liquid crystal devices:
performing, with the control unit, a control such that the voltage applied to the first liquid crystal panel assembly falls and simultaneously the voltage applied to the second liquid crystal panel assembly rises, and such that after a predetermined period has elapsed in the state where the voltage applied to the first liquid crystal panel assembly falls, the voltage applied to the second liquid crystal panel assembly falls.
